(19) United States
(12) Patent Application Publication
(10) Pub. No.: US 2026/0194122 A1
(43) Pub. Date: Jul. 9, 2026

(54) ROTARY DEVICE

(71) Applicant: Nabtesco Corporation, Tokyo (JP)

(72) Inventor: Kazuyoshi MAKISUMI, Tokyo (JP)

(21) Appl. No.: 19/419,580

(22) Filed: Dec. 15, 2025

(30) Foreign Application Priority Data
Jan. 9, 2025 (JP) 2025-003266

(51) Int. Cl. F16H 1/10; F16H 57/021; F16H 57/023

(52) U.S. Cl. CPC F16H 1/10; F16H 57/021; F16H 57/023

(57) ABSTRACT

A rotary device includes: a tubular case; a carrier supported via a first bearing on an inner circumferential surface of the case, the carrier being configured to rotate about an axis of rotation; a plurality of power transmission pins arranged next to each other in a circumferential direction in an outer peripheral portion of the carrier, the plurality of power transmission pins protruding from an outer end face of the carrier facing a direction in which the axis of rotation extends; and a holding plate attached to the plurality of power transmission pins, the holding plate extending over the entire outer peripheral portion of the carrier at the outer end face, the holding plate being configured to restrict movement of the first bearing in an axial direction. Here, hardness of the holding plate is higher than those of the case and carrier.

### CROSS-REFERENCE TO RELATED APPLICATIONS

This application is based on and claims the benefit of priority from Japanese Patent Application Serial No. 2025-003266 (filed on January 9, 2025), the contents of which are hereby incorporated by reference in their entirety.

### TECHNICAL FIELD

The present disclosure relates to a rotary device.

### BACKGROUND

A known type of rotary device is a speed changer having an input section that receives rotation from, for example, an electric motor or the like, and an output section for delivering the rotation after the speed has been reduced or increased. Furthermore, a known type of speed changer is an eccentric oscillation speed reducer that offers high rotational position accuracy and load capacity. This type of speed reducer has, for example, a case, an oscillating gear (external gear), a crankshaft (input shaft), a pin (inner pin), and a carrier. The case has an internal gear formed on its inner circumferential surface. The oscillating gear is meshed with the internal gear and configured to oscillatorily rotate. The crankshaft has an eccentric portion that supports the oscillating gear in a rotatable manner, and is configured to transmit a rotational force to the oscillating gear. The rotational force of the oscillating gear is transmitted to the pin. The carrier is connected to the pin.

The crankshaft is rotatably supported by the carrier via bearings. The carrier is rotatably supported by the case via bearings. The carrier has a pin insertion hole into which the pin is inserted or press-fitted. The oscillating gear, like the carrier, has a pin insertion hole into which the pin is inserted. As the pin is inserted into the pin insertion holes, the rotation of the oscillating gear is transmitted to the carrier via the pin.

In recent years, there has been a demand to reduce the weight of this type of speed reducer. For this reason, various technologies have been proposed to realize lightweight speed reducers. For example, a technology has been proposed in which the pin is formed of metal while the case and carrier are formed by aluminum alloy or resin material (e.g., Japanese Patent Application Publication No. 2019-148308).

However, in the conventional art, application of a preload to the bearings may cause deformation of the case due to the reaction force of the preload. In such cases, the bearings cannot be preloaded properly, resulting in premature damage to the speed reducer. This may possibly shorten the service life of the speed reducer. For example, to prevent deformation of the case, the wall thickness of the case can be increased. However, a thicker case wall will inadvertently lead to the problem that the speed reducer becomes larger in size.

### SUMMARY

The present disclosure provides a rotary device that can achieve reduction in size and weight while accomplishing an extended service life.

(1) An aspect of the present disclosure provides a rotary device including: a tubular first member; a second member supported via a bearing on an inner circumferential surface of the first member, the second member being configured to rotate about an axis of rotation; a plurality of pins arranged next to each other in a circumferential direction in an outer peripheral portion of the second member, the plurality of pins protruding from an end of the second member facing a direction in which the axis of rotation extends; and a plate attached to the plurality of pins, the plate extending over the entire outer peripheral portion of the second member at the end, the plate being configured to restrict movement of the bearing in an axial direction. Here, hardness of the plate is higher than those of the first and second members.

According to the above implementation, the plate can bear the load from the bearing. The hardness of the plate is higher than those of the first and second members. In this way, deformation of the first and second members can be prevented without requiring the first or second member to be thicker than necessary. Deformation of the plate can be also prevented. As a result, the rotary device can achieve reduction in size and weight while accomplishing an extended service life.

(2) In the above configuration, a Young's modulus of the plate may be greater than those of the first and second members.

(3) In the above configuration, the first and second members may contain at least one of aluminum alloy, magnesium alloy, or resin material. The plate may contain at least one of iron alloy or titanium alloy.

(4) In the above configuration, the bearing may include at least one of an angular contact ball bearing or a tapered roller bearing.

(5) In the above configuration, the first member may include a tubular internal gear with internal teeth. The second member may include a carrier rotatably supported by the internal gear via the bearing, the carrier having carrier-side pin insertion holes extending along the axis of rotation. The rotary device may further include an oscillating gear having external teeth meshing with the internal gear, the oscillating gear having gear-side pin insertion holes positioned so as to correspond to the carrier-side pin insertion holes. The plate may have plate-side pin insertion holes coaxially arranged with the carrier-side pin insertion holes. The plurality of pins may be inserted into the carrier-side pin insertion holes, the gear-side pin insertion holes, and the plate-side pin insertion holes. The plate may be attached to the plurality of pins via a fixing member.

The present disclosure can provide a rotary device that can achieve reduction in size and weight while accomplishing an extended service life.

### BRIEF DESCRIPTION OF THE DRAWINGS

FIG. 1 is a sectional view of a speed reducer according to an embodiment of the present disclosure.

FIG. 2 is a partially broken perspective view of the speed reducer according to the embodiment of the present disclosure.

### DESCRIPTION OF THE PREFERRED EMBODIMENTS

The embodiments of the present invention will be hereinafter described with reference to the drawings.

### Speed Reducer

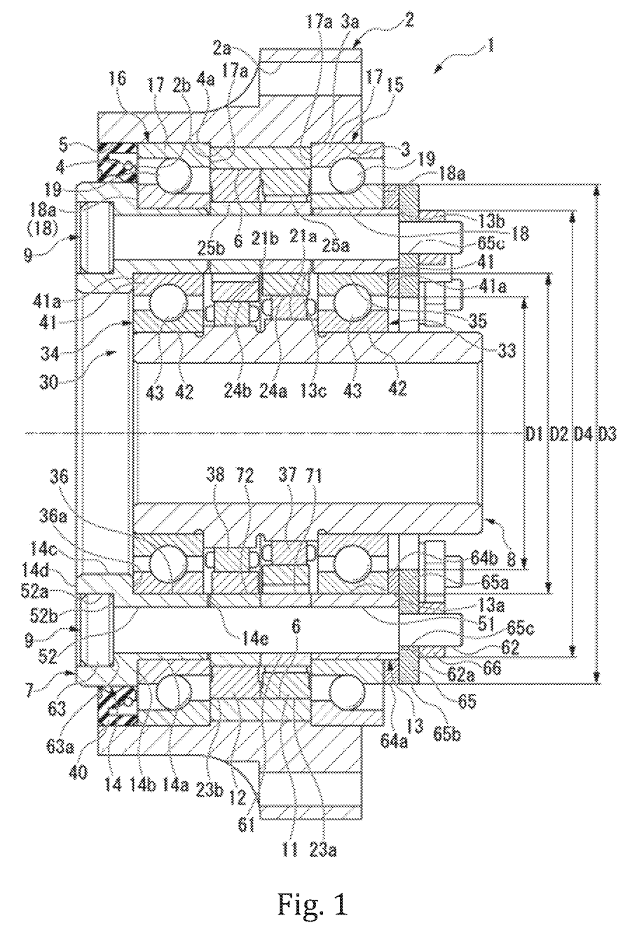

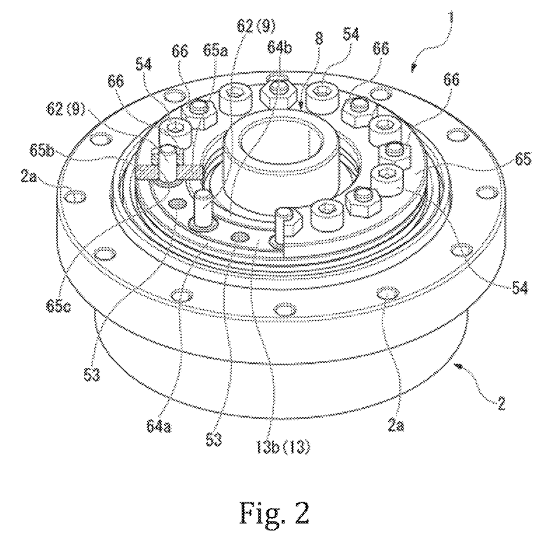

FIG. 1 is a sectional view of a speed reducer 1. FIG. 2 is a partially broken perspective view of the speed reducer 1. The speed reducer 1, which is introduced as an example of a rotary device, is an eccentric oscillation speed reducer. The speed reducer 1 has a cylindrical case 2 (an example of an internal gear and a first member recited in the claims), and a carrier 7 (an example of a second member recited in the claims), which is rotatably supported by the case 2 via two bearings 15 and 16 (a first bearing 15 and a second bearing 16). In the following description, the terms “axial direction,” “axially” and “axial” refer to the axial direction of the case 2. Similarly, the terms “circumferential direction,” “circumferentially” and “circumferential” refer to the circumferential direction of the case 2. Similarly, the terms “radial direction,” “radially” and “radial” refer to the radial direction of the case 2. In relation with the axial direction, the terms “inside” and “outside” may be used to mean the side closer to the middle of the case in the axial direction and the other side.

### Case

The case 2 is made of, for example, an iron-based material such as cast iron. Alternatively, the case 2 may be made of, for example, aluminum alloy, magnesium alloy, carbon fiber reinforced plastic (CFRP), or resin containing boron nitride for improved thermal conductivity. In the outer peripheral portion of the case 2, a plurality of bolt holes 2a penetrating the case 2 in the axial direction are arranged at equal intervals in the circumferential direction. Although not shown, bolts are inserted into the bolt holes 2a. The speed reducer 1 is fixedly secured to an external device by tightening the bolts to the external device.

Bearing housings 3 and 4 (a first bearing housing 3 and a second bearing housing 4) are formed on the inner circumferential surface 2b of the case 2 at the opposing ends of the inner circumferential surface 2b in the axial direction. The bearing housings 3 and 4 have a greater inner diameter than the inner circumferential surface 2b of the case 2 due to steps 3a and 4a.

The portion of the inner circumferential surface 2b of the case 2 positioned on the axially outer side of the second bearing housing 4 forms a seal housing 5. The seal housing 5 fittedly receives a seal 40. The seal 40 seals between the case 2 and the carrier 7.

The portion of the inner circumferential surface 2b of the case 2 that is located between the two bearing housings 3 and 4 has a plurality of internal tooth pins 6. The internal tooth pins 6 are shaped like a circular column extending in the axial direction. The present embodiment is, however, not limited to such, and the internal tooth pins 6 may be hollow members. The internal tooth pins 6 are arranged at regular intervals in the circumferential direction. The internal tooth pins 6 constitute part of a speed reducing mechanism 30. Specifically, the internal tooth pins 6 serve as internal teeth meshing with oscillating gears 11 and 12, which will be described below.

The first bearing 15 is fitted into the first bearing housing 3 of the case 2. The second bearing 16 is fitted into the second bearing housing 4. Since the first and second bearings 15 and 16 have the same configuration, the following description only focuses on the second bearing 16. The first bearing 15 is not described here. The parts of the first bearing 15 are numbered in the same manner as those of the second bearing 16.

The second bearing 16 is made of high-carbon chromium bearing steel, such as SUJ2. The second bearing 16 is a ball bearing. More specifically, the second bearing 16 is, for example, an angular contact ball bearing. The second bearing 16 has an annular outer ring 17, an annular inner ring 18, which is located radially inward to the outer ring 17, and rolling elements 19 located between the outer ring 17 and the inner ring 18. The outer ring 17 is fitted into the second bearing housing 4. The outer ring 17 has an end face 17a that faces inward in the axial direction. The end face 17a butts up against the step 4a of the second bearing housing 4 in the axial direction. The second bearing 16 is thus appropriately positioned with respect to the case 2.

### Speed Reducing Mechanism

The speed reducing mechanism 30 has the carrier 7, power transmission pins 9, a crankshaft 8, two oscillating gears 11 and 12 (a first oscillating gear 11 and a second oscillating gear 12), and a holding plate 65. The power transmission pins 9 are provided in the carrier 7. The crankshaft 8 is rotatably supported by the carrier 7 via two bearings 33 and 34. The two oscillating gears 11 and 12 are rotatably supported by the crankshaft 8. The holding plate 65 is located at one end of the carrier 7 in the axial direction. The axis of rotation of the carrier 7 coincides with the axis of rotation of the crankshaft 8. The axes of rotation coincide with the central axis of the case 2.

The carrier 7 is constituted by a first flange 13 and a second flange 14 facing each other in the axial direction and shaped like a disk. The first and second flanges 13 and 14 are formed of at least one of aluminum alloy, magnesium alloy, or resin material. When the first and second flanges 13 and 14 are formed of aluminum alloy or magnesium alloy, for example, casting is employed. When the first and second flanges 13 and 14 are formed of resin material, injection molding is utilized.

From among the two flanges 13 and 14, the second flange 14 is arranged at the same side as the seal housing 5 of the case 2. This means that the outer circumferential surface of the second flange 14 is fitted to the inner ring 18 of the second bearing 16. The outer circumferential surface of the first flange 13 is fitted to the inner ring 18 of the first bearing 15.

The entire first flange 13 has a uniform thickness in the axial direction. Accordingly, the outer end face 13b and the inner end face 13c of the first flange 13, which respectively face outward and inward in the axial direction, are flat and parallel to each other. The first flange 13 has a first opening 13a at the center in the radial direction that penetrates through the first flange 13 in the axial direction. A third bearing housing 35 is formed in the first opening 13a.

The first flange 13 has a plurality of first bolt insertion holes 51 in the portion located between the outer circumferential surface of the first flange 13 and the third bearing housing 35. The first bolt insertion holes 51 pass through the first flange 13 in the axial direction. The first bolt insertion holes 51 are equally spaced in the circumferential direction. The outer end face 13b of the first flange 13 has internally threaded portions 53 between the first bolt insertion holes 51 in the circumferential direction. The internally threaded portions 53 are equally spaced in the circumferential direction.

The entire second flange 14 has a uniform thickness in the axial direction. Accordingly, the outer end face 14d and the inner end face 14e of the second flange 14, which respectively face outward and inward in the axial direction, are flat and parallel to each other. The outer circumferential surface of the second flange 14 partly faces the seal housing 5 of the case 2 in the radial direction. The seal 40 is fitted to the portion of the second flange 14 that faces the seal housing 5. This can provide sealing between the case 2 and the second flange 14 that constitutes a part of the carrier 7.

The axially inner portion of the outer circumferential surface of the second flange 14 has an outer circumferential bearing housing 14a. The outer circumferential bearing housing 14a has a smaller outer diameter than the second flange 14 via a step 14b. The inner ring 18 of the second bearing 16 is fitted into the outer circumferential bearing housing 14a. The inner ring 18 has an outer end face 18a that faces outward in the axial direction. The outer end face 18a butts up against the step 14b in the axial direction. The second bearing 16 is thus appropriately positioned with respect to the second flange 14.

The second flange 14 has a second opening 14c at the center in the radial direction that extends through the second flange 14 in the axial direction. The inner circumferential surface of the second opening 14c has a fourth bearing housing 36 in the axially inner portion. The fourth bearing housing 36 has a greater inner diameter than the second opening 14c via a step 36a. The fourth bearing housing 36 is arranged next to the outer circumferential bearing housing 14a and to the second bearing housing 4 in the radial direction.

The second flange 14 has a plurality of second bolt insertion holes 52 in the portion located between the outer circumferential bearing housing 14a and the fourth bearing housing 36. The second bolt insertion holes 52 pass through the second flange 14 in the axial direction. The second bolt insertion holes 52 are arranged at equal intervals in the circumferential direction. The first and second bolt insertion holes 51 and 52 are coaxially arranged. The inner diameter of the second bolt insertion holes 52 is equal to that of the first bolt insertion holes 51. Each of the second bolt insertion holes 52 has a counterboring portion 52a on the axially outer side. The counterboring portion 52a has, via a step 52b, a greater inner diameter than the second bolt insertion hole 52.

In the carrier 7 configured in the foregoing manner, the third bearing housing 35 of the first flange 13 fittedly receives a third bearing 33. The fourth bearing housing 36 of the second flange 14 fittedly receives a fourth bearing 34. Since the third and fourth bearings 33 and 34 have the same configuration, the following description only focuses on the fourth bearing 34. The third bearing 33 is not described here. The parts of the third bearing 33 are numbered in the same manner as those of the fourth bearing 34.

The fourth bearing 34 is made of high-carbon chromium bearing steel, such as SUJ2. The fourth bearing 34 is a ball bearing. More specifically, the fourth bearing 34 is, for example, a deep groove ball bearing. The fourth bearing 34 has an annular outer ring 41, an annular inner ring 42, which is located radially inward to the outer ring 41, and rolling elements 43 located between the outer ring 41 and the inner ring 42. The outer ring 41 is fitted into the fourth bearing housing 36. The outer ring 41 has an outer end face 41a that faces outward in the axial direction. The outer end face 41a butts up against the step 36a of the fourth bearing housing 36 in the axial direction. The fourth bearing 34 is thus appropriately positioned with respect to the second flange 14.

The bolt insertion holes 51 and 52 of the flanges 13 and 14 receive the power transmission pins 9. The power transmission pins 9 are formed of, for example, aluminum chromium molybdenum steels. Each power transmission pin 9 has a columnar shaft 61, an externally threaded portion 62 integrally formed on one end of the shaft 61 in the axial direction, and a head 63 integrally formed on the other end of the shaft 61 in the axial direction. The shaft 61, externally threaded portion 62, and head 63 are arranged coaxially.

The outer diameter of the shaft 61 is equal to or slightly smaller than the inner diameter of the first bolt insertion holes 51 and that of the second bolt insertion holes 52. The externally threaded portion 62 has a smaller outer diameter than the shaft 61 via a threaded step 62a. The head 63 has, via a step 63a, a greater outer diameter than the shaft 61. The outer diameter of the head 63 is slightly smaller than the outer diameter of the counterboring portion 52a of the second flange 14.

Configured in the above manner, the power transmission pin 9 is inserted, from the second flange 14 side, into the second bolt insertion hole 52 and then the first bolt insertion hole 51 with the externally threaded portion 62 facing the first flange 13. The head 63 of the power transmission pin 9 is inserted into the counterboring portion 52a of the second bolt insertion hole 52. The step 63a of the power transmission pin 9 butts up against the step 52b of the second bolt insertion hole 52 in the axial direction. This allows the power transmission pin 9 to be appropriately positioned with respect to the second flange 14 in the axial direction.

On the other hand, the externally threaded portion 62 of the power transmission pin 9 protrudes through the first bolt insertion hole 51 and beyond the first flange 13 outward in the axial direction. The holding plate 65 is located on the outer end face 13b of the first flange 13, through which the externally threaded portion 62 protrudes.

The holding plate 65 is a plate-shaped member that is annular when viewed in the axial direction and arranged correspondingly to the positions of the power transmission pins 9. The holding plate 65 is formed of at least one of iron alloy or titanium alloy. Therefore, the hardness of the holding plate 65 is higher than that of the carrier 7 (the first and second flanges 13 and 14) and that of the case 2. In other words, the Young's modulus of the holding plate 65 is greater than that of the carrier 7 (the first and second flanges 13 and 14) and that of the case 2. More specifically, for example, if the holding plate 65 is formed of iron alloy, the Young's modulus of the holding plate 65 is about 190 to 210 GPa. For example, the Young's moduli of the carrier 7 and case 2 are about 70 to 80 GPa if they are formed of aluminum alloy, and about 120 GPa if they are formed of aluminum composite material.

The inner diameter D1 of the holding plate 65 is less than the inner diameter D2 of the first opening 13a of the first flange 13. This means that the inner peripheral portion 65a of the holding plate 65 extends inward in the radial direction beyond the first opening 13a of the first flange 13. The inner peripheral portion 65a of the holding plate 65 faces the outer ring 41 of the third bearing 33 in the axial direction. The outer diameter D3 of the holding plate 65 is greater than the diameter D4 of the outer circumferential surface of the first flange 13. This means that the outer peripheral portion 65b of the holding plate 65 extends outward in the radial direction beyond the outer circumferential surface of the first flange 13. The outer peripheral portion 65b of the holding plate 65 faces the inner ring 18 of the first bearing 15 in the axial direction.

Although not shown, the entire peripheral portion of the holding plate 65 has through holes, which are coaxially arranged with the internally threaded portions 53 of the first flange 13. Bolts 54 are inserted into these through holes from above the holding plate 65, and tightened to the corresponding internally threaded portions 53. The holding plate 65 is thus fixedly secured to the first flange 13.

The entire peripheral portion of the holding plate 65 has external thread insertion holes 65c, which are coaxially arranged with the power transmission pins 9. The diameter of the external thread insertion holes 65c is greater than the shaft diameter of the externally threaded portions 62 of the power transmission pins 9 and less than the outer diameter of the shafts 61. The external thread insertion holes 65c receive the externally threaded portions 62. Nuts 66 are tightened on the externally threaded portions 62 from above the holding plate 65. The power transmission pins 9 are thus fixedly secured to the carrier 7 (the first and second flanges 13 and 14).

An annular first spacer 64a is provided between the inner ring 18 of the first bearing 15 and the holding plate 65. An annular second spacer 64b is provided between the outer ring 41 of the third bearing 33 and the holding plate 65. The thickness of the first spacer 64a is determined such that the inner ring 18 is slightly pressed inward in the axial direction by the first spacer 64a. As a result, the first bearing 15 is preloaded. The holding plate 65 also serves to restrict the movement of the first bearing 15 in the axial direction.

As mentioned above, the preload on the first bearing 15 results from tightening the nuts 66 on the externally threaded portions 62, which causes the holding plate 65 to press the inner ring 18 via the first spacer 64a. Therefore, the holding plate 65 is subjected to a reaction force from the first bearing 15. Here, the hardness of the holding plate 65 is higher than that of the carrier 7 (the first and second flanges 13 and 14) and that of the case 2. The reaction force from the first bearing 15 thus does not cause deformation of the holding plate 65. As a result, the holding plate 65 can apply a desired preload to the first bearing 15.

With the power transmission pins 9 fixed, two bushings 71 and 72 (a first bushing 71 and a second bushing 72) are fitted to the portion of the shaft 61 that is located between the first and second flanges 13 and 14. The bushings 71 and 72 are made of high-carbon chromium bearing steel, such as SUJ2. In other words, the hardness of the bushings 71 and 72 is equal to that of the bearings 15, 16, 33 and 34.

The crankshaft 8 is rotatably supported by the flanges 13 and 14 via the third and fourth bearings 33 and 34. Like the power transmission pins 9, the crankshaft 8 is made of, for example, aluminum alloy. Like the power transmission pins 9, the crankshaft 8 may be made of other possible materials such as stainless steels or various ferrous metals.

The crankshaft 8 is hollow. On the outer circumferential surface of the crankshaft 8, a first eccentric portion 21a and a second eccentric portion 21b are formed next to each other in the axial direction in the portion located between the third and fourth bearings 33 and 34. The first eccentric portion 21a is closer to the first flange 13. The second eccentric portion 21b is closer to the second flange 14. The eccentric portions 21a and 21b are eccentrically arranged with respect to the axis of rotation of the crankshaft 8 (the carrier 7). The eccentric portions 21a and 21b are out of phase with each other. For example, the eccentric portions 21a and 21b are out of phase with each other by 180°.

The eccentric portions 21a and 21b are respectively provided with bearings 37 and 38 (a fifth bearing 37 and a sixth bearing 38). These bearings 37 and 38 are needle bearings, for example. The oscillating gears 11 and 12 (the first and second oscillating gears 11 and 12) are rotatably supported on the eccentric portions 21a and 21b via the bearings 37 and 38. In other words, the oscillating gears 11 and 12 are disposed between the first and second flanges 13 and 14.

The two oscillating gears 11 and 12 are made of, for example, an iron-based material such as chrome molybdenum steel. The two oscillating gears 11 and 12 respectively have crankshaft insertion holes 24a and 24b (a first crankshaft insertion hole 24a, a second crankshaft insertion hole 24b) at their centers in the radial direction. The crankshaft insertion holes 24a and 24b extend through the oscillating gears 11 and 12 in the thickness direction. The bearings 37 and 38 are fitted into the crankshaft insertion holes 24a and 24b, respectively. External teeth 23a and 23b that mesh with the internal tooth pins 6 provided on the case 2 are formed on the outer peripheral portions of the two oscillating gears 11 and 12, respectively. The number of external teeth 23a and 23b is smaller than that of the internal tooth pins 6 by, for example, one.

The two oscillating gears 11 and 12 have pin insertion holes 25a and 25b (first pin insertion holes 25a and second pin insertion holes 25b) that are aligned with the power transmission pins 9. The shafts 61 of the power transmission pins 9 pass through the pin insertion holes 25a and 25b. From among the pin insertion holes 25a and 25b, the first pin insertion holes 25a receive the first bushings 71, which are fitted onto the shafts 61. From among the pin insertion holes 25a and 25b, the second pin insertion holes 25b receive the second bushings 72, which are fitted onto the shafts 61.

With the foregoing configurations, the eccentric portions 21a and 21b of the crankshaft 8 can cause the oscillating gears 11 and 12 to oscillatorily rotate. The inner diameters of the pin insertion holes 25a and 25b of the oscillating gears 11 and 12 are large enough to allow the oscillatory rotation of the oscillating gears 11 and 12 with the shafts 61 of the power transmission pins 9 and the bushings 71 and 72 being inserted in the pin insertion holes 25a and 25b.

### How Speed Reducer Works

The following now describes how the speed reducer 1 works. Upon rotation of the crankshaft 8, which is caused by a not-shown electric motor, the oscillating gears 11 and 12 rotatably supported by the eccentric portions 21a and 21b may oscillatorily rotate. This causes some of the external teeth 23a and 23b of the oscillating gears 11 and 12 to mesh with the internal tooth pins 6 of the case 2. Since the number of external teeth 23a and 23b is less than that of the internal tooth pins 6 by, for example, one, the meshing positions of the external teeth 23a and 23b with the internal tooth pins 6 (case 2) move sequentially in the circumferential direction while the oscillating gears 11 and 12 rotate on their own axes. The rotation of the oscillating gears 11 and 12 on their own axes is at a lower speed than the rotation of the crankshaft 8.

The power transmission pins 9 pass through the pin insertion holes 25a and 25b of the oscillating gears 11 and 12. Therefore, as the oscillating gears 11 and 12 rotate on their own axes, the rotational force in the direction of rotation of the oscillating gears 11 and 12 on their own axes is transmitted to the power transmission pins 9 via the bushings 71 and 72. In other words, the bushings 71 and 72 slide, together with the corresponding oscillating gears 11 and 12. The power transmission pins 9 are fixedly attached onto the carrier 7 (the first and second flanges 13 and 14). Therefore, the rotational force of the oscillating gears 11 and 12 is transmitted to the carrier 7 via the power transmission pins 9. The carrier 7 is rotatably supported by the case 2 via the first and second bearings 15 and 16. As a result, the carrier 7 rotates with respect to the case 2. Therefore, the rotation is input into the crankshaft 8, reduced and then output through the carrier 7.

Here, the first bearing 15 is preloaded to a desired degree. This preload eliminates play of the first bearing 15 in the axial and radial directions and increases axial rigidity. As a result, axial runout is prevented during rotation of the carrier 7.

The speed reducer 1 described above has the annular holding plate 65 that is secured with the power transmission pins 9, arranged on the outer end face 13b of the first flange 13 and extends over the entire outer peripheral portion of the first flange 13. The holding plate 65 restricts the movement of the first bearing 15 in the axial direction. The hardness of the holding plate 65 is higher than that of the carrier 7 and that of the case 2. More specifically, the Young's modulus of the holding plate 65 is greater than that of the carrier 7.

The holding plate 65 can thus bear the load from the first bearing 15. Moreover, deformation of the holding plate 65 and carrier 7 can be prevented without requiring the holding plate 65 and carrier 7 to be thicker than necessary. Therefore, the speed reducer 1 can achieve reduction in size and weight while accomplishing an extended service life.

The carrier 7 is formed of at least one of aluminum alloy, magnesium alloy, or resin material. The holding plate 65 is formed of at least one of iron alloy or titanium alloy. This can ensure that the portion that applies load to the first bearing 15 has a sufficient strength. For example, the holding plate 65 can be arranged to load the first bearing 15. In addition, the carrier 7 can be made lighter.

The first bearing 15 is an angular contact ball bearing. Therefore, preloading the first bearing 15 results in eliminating play of the first bearing 15 in the axial and radial directions and increasing the axial rigidity. As a result, axial runout can be prevented during rotation of the carrier 7.

The embodiments described herein are not intended to necessarily limit the present invention to any specific embodiments. Various modifications can be made to these embodiments without departing from the true scope and spirit of the present invention.

For example, the above embodiment describes the speed reducer 1 as an example of rotary device. The present embodiment, however, is not limited to such, and the configuration of the speed reducer 1 described above can be employed in various types of rotary devices. Any types of rotary devices are accepted as long as they include: a tubular first member, for which the case 2 is introduced as an example; a second member rotatably supported by the inner circumferential surface of the first member, for which the carrier 7 is introduced as an example; the pins inserted into the pin insertion holes in the second member; and the holding plate 65 attached to the pins. The holding plate 65 can be configured in any manner as long as it can restrict the movement of the bearing in the axial direction. The hardness of the holding plate 65 can be at any level as long as it is higher than those of the first and second members.

The above embodiment describes the speed reducer 1 including the speed reducing mechanism 30 that can reduce the rotation of the crankshaft 8 and output the reduced rotation. The embodiment is, however, not limited to such, and the above-described power transmission pins 9 may be applied to speed increasers in place of the speed reducing mechanism 30. Furthermore, the power transmission pins 9 described above may be employed in any rotary devices that have a component comparable to the speed reducing mechanism 30 (i.e., the carrier 7 and oscillating gears 11 and 12). The component comparable to the speed reducing mechanism 30 is only required to have pin insertion holes (the pin insertion holes 25a and 25b) for receiving the power transmission pins 9.

According to the foregoing embodiment, the speed reducing mechanism 30 has one crankshaft 8, and the axis of rotation of the carrier 7 and the axis of rotation of the crankshaft 8 are coincident. The present embodiment, however, is not limited to such, and the speed reducing mechanism 30 can be configured in any other manner as long as it is an eccentric oscillation speed reducing mechanism where the two oscillating gears 11 and 12 are configured to oscillatorily rotate. For example, the speed reducing mechanism 30 may alternatively have three crankshafts 8 that are arranged around the axis of rotation of the carrier 7. These crankshafts 8 may be used to cause the two oscillating gears 11 and 12 to oscillatorily rotate.

In the embodiment described above, the first bearing 15 is an angular contact ball bearing. The present embodiment, however, is not limited to such, and various types of bearings can be employed as the first bearing 15. The first bearing 15 is preferably configured to receive a preload. For example, the first bearing may be a tapered roller bearing. In this way, the first bearing 15 can achieve improved axial rigidity.

The foregoing embodiments disclosed herein describe a plurality of physically separate constituent parts. They may be combined into a single part, and any one of them may be divided into a plurality of physically separate constituent parts. Irrespective of whether or not the constituent parts are integrated, they are acceptable as long as they are configured to attain the object of the invention.

What is claimed is:

1. A rotary device comprising:
a tubular first member;
a second member supported via a bearing on an inner circumferential surface of the first member, the second member being configured to rotate about an axis of rotation;
a plurality of pins arranged next to each other in a circumferential direction in an outer peripheral portion of the second member, the plurality of pins protruding from an end of the second member facing a direction in which the axis of rotation extends; and
a plate attached to the plurality of pins, the plate extending over the entire outer peripheral portion of the second member at the end, the plate being configured to restrict movement of the bearing in an axial direction,
wherein hardness of the plate is higher than those of the first and second members.

2. The rotary device of claim 1, wherein a Young's modulus of the plate is greater than those of the first and second members.

3. The rotary device of claim 1,
wherein the first and second members contain at least one of aluminum alloy, magnesium alloy, or resin material, and
wherein the plate contains at least one of iron alloy or titanium alloy.

4. The rotary device of claim 1, wherein the bearing includes at least one of an angular contact ball bearing or a tapered roller bearing.

5. The rotary device of claim 1
a tubular internal gear with internal teeth,
wherein the second member includes a carrier rotatably supported by the internal gear via the bearing, the carrier having carrier-side pin insertion holes extending along the axis of rotation,
wherein the rotary device comprises an oscillating gear having external teeth meshing with the internal gear, the oscillating gear having gear-side pin insertion holes positioned so as to correspond to the carrier-side pin insertion holes,
wherein the plate has plate-side pin insertion holes coaxially arranged with the carrier-side pin insertion holes,
wherein the plurality of pins are inserted into the carrier-side pin insertion holes, the gear-side pin insertion holes, and the plate-side pin insertion holes, and
wherein the plate is attached to the plurality of pins via a fixing member.
